(19) United States
(12) Patent Application Publication
(10) Pub. No.: US 2019/0102541 A1
(43) Pub. Date: Apr. 4, 2019

(54) APPARATUS AND METHOD FOR DEFENDING AGAINST UNAUTHORIZED MODIFICATION OF PROGRAMS

(71) Applicant: SAMSUNG ELECTRONICS CO., LTD., Suwon-si (KR)

(72) Inventors: Seok Hwan JO, Suwon-si (KR); Eun Kyoung PARK, Seoul (KR); Woo Seok KANG, Suwon-si (KR)

(73) Assignee: SAMSUNG ELECTRONICS CO., LTD., Suwon-si (KR)

(21) Appl. No.: 16/144,190

(22) Filed: Sep. 27, 2018

(30) Foreign Application Priority Data
Sep. 29, 2017 (KR) 10-2017-0127960

(51) Int. Cl. G06F 21/54; G06F 21/56; G06F 21/62; G06F 11/36

(52) U.S. Cl. CPC G06F 21/54; G06F 11/3636; G06F 21/6281; G06F 21/566

(57) ABSTRACT

An apparatus and method for defending against an unauthorized modification of a program are disclosed. The apparatus for defending against an unauthorized modification of a program may include a first processor for executing the program, and a second processor that is physically separated from the first processor and for acquiring a first variable value defined in a data definition part. The second processor compares a second variable value used in a data use part with the first variable value when the part of the program being executed by the first processor is the data use part, it may be determine whether or not the program has been modified without authorization based on a result of the comparison.

### CROSS-REFERENCE TO RELATED APPLICATION

This application is based on and claims priority under 35 U.S.C. § 119 to Korean Patent Application No. 10-2017-0127960, filed on Sep. 29, 2017 in the Korean Intellectual Property Office, the disclosure of which is incorporated by reference in its entirety.

### BACKGROUND

### 1. Field

Embodiments of the present disclosure relate to an apparatus and method for defense against an unauthorized modification of a program.

### 2. Description of the Related Art

A program (also called an application or an app) is a set of at least one instruction that is installed on a hardware device and executes an algorithm to perform a specific task. Recently, most electronic devices store and execute such a program.

A processor of an electronic device, for example, a Central Processing Unit (CPU) or a Micro Controller Unit (MCU) executes at least one program to cause the electronic device to perform a predetermined operation. The electronic device may be a digital television, a smart phone, a tablet PC, a desktop computer, a laptop computer, a refrigerator, a robot cleaner, a vehicle, a construction machine, or an industrial robot.

However, when a part of the program is modified without authorization, the program may be executed in a different way from the original intention. In this case, the electronic device that executes the program may perform an unexpected operation or stop operating. Recently, there are many cases where hackers (including crackers) gain illegal profits by modifying programs that are installed on electronic devices without proper authority to prevent the electronic devices from performing scheduled operations. Therefore, a method for preventing unauthorized modifications of programs by hackers is needed.

### SUMMARY

Therefore, it is an aspect of the present disclosure to provide an apparatus and method for defending against a modification of a program, which is capable of enhancing the safety of the program by appropriately defending against an external attack on the program.

Additional aspects of the present disclosure will be set forth in part in the description which follows and, in part, will be obvious from the description, or may be learned by practice of the present disclosure.

In accordance with one aspect of the present disclosure, an apparatus for defending against an unauthorized modification of a program includes: a first processor configured to execute the program; and a second processor configured to monitor an execution state of the program being executed by the first processor, wherein the second processor includes: acquiring a first value of a defined variable when a data definition part of the program is executed, and determining whether the program has been modified without authorization based on a result of comparison between the first value and a second value used as the value of the variable when a data use part of the program is executed.

The second processor may be independent of the first processor.

The second processor may determine that the program has been not modified without authorization when the first value is identical to the second value, and determine that the program has been modified without authorization when the first value is different from the second value.

The second processor may control the first processor to stop executing the program according to the determination of whether the program has been modified without authorization.

The second processor may acquire reference information corresponding to the program and related to the data definition part and the data use part by analyzing the program before the first processor executes the program or by receiving the reference information from another computing device.

The second processor may determine whether a part of the program being executed by the first processor is the data definition part or the data use part by using the reference information.

The apparatus for defending against an unauthorized modification of program may further include a storage configured to store a value of at least one variable defined by the data definition part of the program.

The first processor may call and execute a library function, and store a variable defined by the library function or a value of the variable stored in the storage, and the second processor may determine whether the variable or the value of the variable stored in the storage has been modified without authorization, and determine whether the program has been modified without authorization based on a result of the determination.

The second processor may check integrity of the library function before the program is executed by the first processor.

The second processor may include a first monitor to monitor an operation of the first processor and a second monitor to monitor a state of the storage.

In accordance with another aspect of the present disclosure, an apparatus for defending against an unauthorized modification of a program includes: a storage; a first processor configured to execute at least one library function included in the program and to store at least one variable defined by the at least one library function or a value corresponding to the at least one variable in the storage; and a second processor configured to determine whether or not the program has been modified without authorization according a determination on whether the variable or the value of the variable stored in the storage has been modified without authorization.

In accordance with another aspect of the present disclosure, a method for defending against an unauthorized modification of program includes: by a first processor, executing a program; by a second processor, acquiring a first value of a defined variable when a data definition part of the program is executed; by the second processor, comparing the first value to a second value used as a value of the variable when a data use part of the program is executed; and by the second processor, determining whether the program has been modified without authorization based on a result of the comparison.

The determining of whether the program has been modified without authorization based on the result of the comparison may include at least one of by the second processor, determining that the program has been not modified without authorization when the first value is identical to the second value, and by the second processor, determining that the program has been modified without authorization when the first value is different from the second value.

The method may further include by the second processor, controlling the first processor to stop executing the program in response to the determination that the program has been modified without authorization.

The method may further include by the second processor, acquiring reference information corresponding to the program and related to the data definition part and the data use part, wherein the acquiring of the reference information may include at least one of: analyzing the program to acquire the reference information before the first processor executes the program; and receiving the reference information from another computing method to acquire the reference information.

The determining of whether the program has been modified without authorization based on the result of the comparison may further include by the second processor, determining whether a part of the program being executed by the first processor is the data definition part or the data use part by using the reference information.

The method may further include storing a value of at least one variable defined by the data definition part of the program in the storage.

The method may further include by the first processor, calling and executing a library function; storing a variable defined by the library function or a value of the variable in the storage; by the second processor, determining whether the variable or the value of the variable stored in the storage has been modified without authorization; and determining whether the program has been modified without authorization based on a result of the determination.

The method may further include by the second processor, checking integrity of the library function before the program is executed by the first processor.

The method may further include at least one of by the second processor, monitoring an operation of the first processor; and by the second processor, monitoring a state of the storage.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a block diagram illustrating an embodiment of an apparatus for defending against an unauthorized modification of a program.

FIG. 2 shows an example of a program.

FIG. 3 is a view for describing an example of a Control-Flow Bending (CFB) attack on the program shown in FIG. 2.

FIG. 4 is a view for describing another example of a CFB attack on the program shown in FIG. 2.

FIG. 5 shows a control flow of an apparatus for defending against an unauthorized modification of a program.

FIG. 6 is a table showing operations of individual components of an apparatus for defending against an unauthorized modification of a program, according to instructions executed.

FIG. 7 shows a control flow of an apparatus for defending against an unauthorized modification of a program when the program uses a library function.

FIG. 8 is a flowchart illustrating an embodiment of a method for defending against an unauthorized modification of a program.

FIG. 9 is a flowchart illustrating another embodiment of a method for defending against an unauthorized modification of a program.

FIG. 10 is a flowchart illustrating still another embodiment of a method for defending against an unauthorized modification of a program.

### DETAILED DESCRIPTION

Like numbers refer to like elements throughout this specification. This specification does not describe all components of the embodiments, and general information in the technical field to which the present disclosure belongs or overlapping information between the embodiments will not be described. The terms “portion”, “module”, “element”, and “block”, as used herein, may be implemented as software or hardware, and according to embodiments, a plurality of “portion”, “module”, “element”, and “block” may be implemented as a single component, or a single “portion”, “module”, “element”, and “block” may include a plurality of components.

It will be understood that when a component is referred to as being “connected” to another component, it can be directly or indirectly connected to the other component. When a component is indirectly connected to another component, it may be connected to the other component through a wireless communication network.

Also, it will be understood that when the terms “includes,” “comprises,” “including,” and/or “comprising,” when used in this specification, specify the presence of a stated component, but do not preclude the presence or addition of one or more other components.

It will be understood that, although the terms first, second, etc. may be used herein to describe various components, these components should not be limited by these terms. These terms are only used to distinguish one component from another.

It is to be understood that the singular forms “a,” “an,” and “the” include plural referents unless the context clearly dictates otherwise.

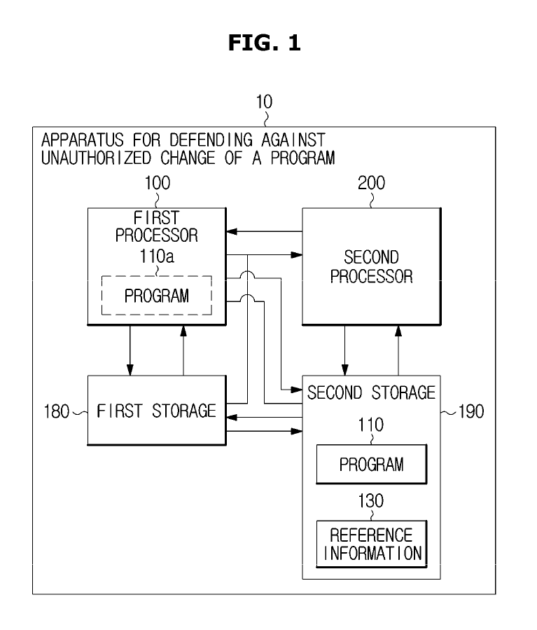

An apparatus for defending against an unauthorized modification of a program, according to embodiments of the present disclosure, will hereinafter be described with reference to FIGS. 1 to 7.

FIG. 1 is a block diagram illustrating an embodiment of an apparatus for defending against an unauthorized modification of a program.

Referring to FIG. 1, an apparatus 10 for defending against an unauthorized modification of a program may include a first processor 100 and a second processor 200. If necessary, the apparatus 10 for defending against the unauthorized modification of the program may include at least one of a first storage 180 and a second storage 190.

The apparatus 10 for defending against the unauthorized modification of the program may be an electronic device that can perform a specific operation according to execution of a program by the first processor 100 and the second processor 200. For example, the apparatus 10 for defending against the unauthorized modification of the program 10 may be a display (for example, a television, an electronic advertising board, an electronic board, a monitor, etc.), a set-top box, a desktop computer, a laptop computer, a smart phone, a tablet PC, a personal digital assistant (PDA), a game machine, a home appliance (for example, a cleaner, a refrigerator, a washing machine, etc.), an industrial machine, an industrial robot, a navigation system, a vehicle, a construction machine, an aircraft, or the like. However, the apparatus 100 for defending against the unauthorized modification of the program is not limited to the above-mentioned apparatuses, and may be one of various apparatuses that are used in various fields, according to a designer's determination and selection.

The first processor 100 may execute programs 110 and 110a to perform a predetermined operation or a predetermined control process. If necessary, the first processor 100 may call all or a part of the programs 110 and 110a.

In more detail, for example, the first processor 100 may call instructions constituting the programs 110 and 110a in a predetermined order, analyze the called instructions, and operate according to the analyzed instructions, thereby executing the programs 110 and 110a and the corresponding operations.

The first processor 100 may include a Central Processing Unit (CPU), a Micro Controller Unit (MCU), a Micro Processor (Micom), an Application Processor (AP), an Electronic Control Unit (ECU) and/or various kinds of processing units that can perform various calculations and generate control signals. The above-mentioned devices may be implemented using, for example, one or more semiconductor chips and associated elements.

The second processor 200 may monitor and determine whether the programs 110 and 110a have been modified, when the programs 110 and 110a are processed by the first processor 100.

In more detail, for example, the second processor 200 may determine whether a part (i.e., an instruction, etc.) processed by the first processor 100 is a data definition part or a data use part. The second processor 200 may store the defined data (i.e., a first variable value) and/or compare the used data (i.e., a second variable value) to stored data according to the result of the determination, and determine whether the programs 110 and 110a have been modified based on the result of the comparison.

Herein, the data definition part may be a part defining data, and include, for example, a statement that declares a variable and/or a statement that defines a variable, etc. In addition, the data use part may be a part using predefined data, and include, for example, a part where a function, a routine, or a subroutine exists.

In addition, for another example, the second processor 200 may determine whether or not a variable or a variable value stored in the first storage 180 has been modified without authorization according to the process by the first processor 100, and determine whether the programs 110 and 110a have been modified without authorization according to the result of the determination on whether the variable or the variable value stored in the storage 180 has been modified without authorization.

According to an embodiment, the second processor 200 may determine whether the above-mentioned programs 110 and 110a have been modified without authorization by further using reference information 130 stored in the second storage 190.

The process in which the second processor 200 determines whether the programs 110 and 110a have been modified without authorization will be described in detail, later.

The second processor 200 may be provided independently of the first processor 100. In other words, the second processor 200 may be physically or logically separated from the first processor 100, and/or may be provided to be capable of operating independently of the first processor 100. The second processor 200 may be configured to perform, when the first processor 100 performs a predetermined operation, an operation that is different from the predetermined operation. For example, when the first processor 100 processes the program 110a, the second processor 200 may perform an operation of determining whether or not the program 110a has been modified without authorization without processing the program 110a. Accordingly, even when the programs 110 and 110a modified without proper authority are executed so that the first processor 100 performs an unintended operation, the second processor 200 may determine whether the programs 110 and 110a processed by the first processor 100 have been modified without authorization, without being affected by the unintended operation.

The second processor 200 may be implemented using, for example, a CPU, a MCU, a Micom, an application processor, an ECU, and/or another processing unit that can perform various calculations and generate control signals.

The second processor 200 may be physically separated from the first processor 100. For example, the first processor 100 and the second processor 200 may be implemented using different semiconductor chips (further including related circuit elements as necessary). In this case, the second processor 200 may be implemented using the same type of device as the first processor 100 or using a different type of device from the first processor 100. In the latter case, for example, the first processor 100 may be implemented using a CPU, and the second processor 200 may be implemented using an AP which is a System on Chip (SoC).

In addition, each of the first processor 100 and the second processor 200 may be implemented using a plurality of cores installed in a multicore processor. More specifically, for example, in the case of a dual-core processor, one of two cores integrated in a monolith may be used as the first processor 100, and the other core may be used as the second processor 200. It may be equally applicable to a quad-core processor, a penta-core processor, an octa-core processor, or the like, in the same way or through some modifications. In this case, both the first processor 100 and the second processor 200 may be implemented by a single semiconductor chip without being physically separated.

The first storage 180 may temporarily or non-temporarily store various data generated when the first processor 100 and/or the second processor 200 operates. For example, the first storage 180 may temporarily store variable values or processing results acquired when the first processor 100 processes the program 110a, and provide the stored variable values or processing results to the first processor 100 according to a call from the first processor 100.

The first storage 180 may be, for example, a cache memory. In addition, for another example, the first storage 180 may be a main storage device. When the first storage 180 is a cache memory or a main storage device, the first storage 180 may be implemented using, for example, a Random Access Memory (RAM). In this case, the RAM may be at least one of a Static Random Access memory (SRAM) or Dynamic Random Access Memory (DRAM).

The second storage 190 may store various algorithms and information required for an operation of at least one of the first processor 100 and the second processor 200. For example, the second storage 190 may store the entire or a part of the program 110 to be executed by the first processor 100. In another example, the second storage 190 may store the reference information 130 that is used by the second processor 200 to determine whether the programs 110 and 110a have been modified without authorization. The second storage 190 may provide an algorithm or information requested by at least one of the first processor 100 or the second processor 200 according to a call from at least one of the first processor 100 or the second processor 200.

The second storage 190 may be, for example, an auxiliary storage device. In this case, the second storage 190 may be implemented using magnetic disk storage medium (for example, a hard disk or a floppy disk), a magnetic tape, optical medium (for example, a Compact Disk (CD) or a Digital Versatile Disk (DVD)), magneto-optical medium (for example, a floptical disk), or a semiconductor storage device (for example, Read Only Memory (ROM), Random Access Memory (RAM), a SD card, a flash memory, and a Solid State Drive (SSD)).

FIG. 1 shows an example in which the apparatus 10 for defending against the unauthorized modification of the program 10 includes two storages 180 and 190. However, the number of the storages 180 and 190, which can be included in the apparatus 100 for defending against the unauthorized modification of the program, is not limited to two. According to some embodiments, the apparatus 10 for defending against the unauthorized modification of the program may include a single storage or three or more storages.

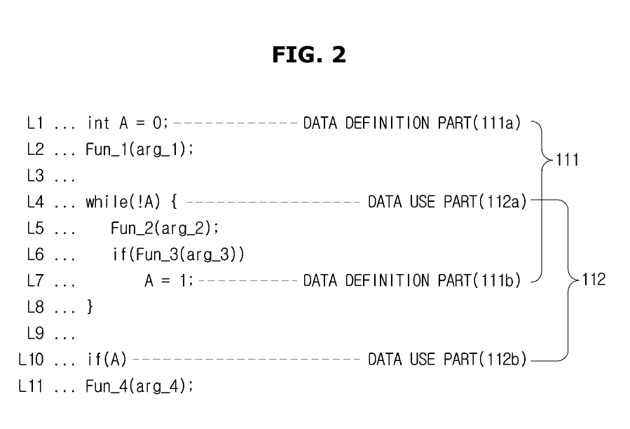

FIG. 2 shows an example of a program that can be written in the C language or the similar language. The programs 110 and 110a which will be described below are not limited to those shown in FIG. 2.

The programs 110 and 110a may be a set of instructions that can be analyzed and processed by a device capable of performing operations and/or control processing, such as the first processor 100 or the second processor 200. The programs 110 and 110a may be implemented in at least one programming language that can be considered by a designer. In this case, the at least one programming language may include lower level languages, such as a machine language or an assembly language, or higher level languages, such as an interpreter language or a compiling language. The higher level languages may include COBOL, PASCAL, FORTRAN, C, C++, Delphi, BASIC, Java, C#, or LISP.

The program 110 may be stored in predetermined storages 180 and 190. For example, the program 110 may be stored in the second storage 190 used as an auxiliary storage device. However, the program 110 may be temporarily or non-temporarily stored in the first storage 180 used as a main storage.

The program 110 stored in the first and/or second storages 180 and/or 190 may have been written on the apparatus 10 for defending against the unauthorized modification of the program directly by, for example, a user.

In addition, the program 110 stored in the first and/or second storages 180 and/or 190 may have been received from an external source. In this case, the program 110 may have been inputted and acquired through a hardware interface (not shown) provided in the apparatus 10 for defending against the unauthorized modification of the program, such as a serial port, a parallel port, a SCSI port, an Universal Serial Bus (USB) terminal, a LAN terminal (RJ-45, etc.), a RF terminal, a composite terminal, a component terminal, and etc. The program 110 may have also been acquired from an external computing device by using a wireless communication module (not shown) connected to or installed in the apparatus 10 for defending against the unauthorized modification of the program. The wireless communication module may be implemented using, for example, short-range communication technology, such as a CAN communication, Wi-Fi, Zigbee, Bluetooth, Wi-Fi Direct, Bluetooth Low Energy, and Near Field Communication (NFC), and/or using mobile communication technology, such as 3GPP, 3GPP2, and WiMAX series, to communicate with external computing devices. The program 110 may have been acquired through an electronic software distribution network. The program 110 may be updated in the same manner as the above-mentioned communication methods.

The program 110 may be provided in whole or in part to at least one of the processors 100 and 200 in accordance with a call from the at least one of the processors 100 and 200. The program 110 may be implemented, for example, in the form of a plurality of lines L1 to L11 each including a predetermined instruction and data, as shown in FIG. 2. At least one of the lines L1 to L11 included in the program 110 may be sequentially provided to at least one of the processors 100 or 200 in a predefined order. In this case, the at least one of the lines L1 to L11 may be temporarily stored in the first storage 180, and then transmitted to the processors 100 and 200. At least one of the processors 100 and 200 may analyze the at least one of the acquired lines L1 to L11, and perform calculation and control processing according to the result of the analysis to execute the program 110a.

The program 110 may include a data definition part 111 that declares a variable and/or defines an actual value (hereinafter, a variable value) of the variable, and a data use part 112 that uses the declared variable and/or variable value. The program 110 may include one or a plurality of data definition parts 111a and 111b and one or a plurality of data use parts 112a and 112b. Generally, the data definition parts 111a and 111b may be located before the data use parts 112a and 112b that use defined data.

For example, in the first data definition part 111a, a variable A having an integer value may be declared (int A) and/or a variable value (for example, zero) of the variable A may be assigned and defined (int A=0), as shown in the first line L1 of FIG. 2.

In the first data use part 112a, a predetermined function, for example, a while function may be performed using the variable value of the declared variable A. More specifically, for example, the while function defined in the fourth line L4 may repeatedly perform a predefined operation, for example, functions or definitions of the fifth to seventh lines L5 to L7, depending on whether the variable A satisfies a condition (e.g., whether it is “true” or “false”).

Data may be newly defined or redefined (the second data definition part 111b) while the predetermined function is being performed. For example, when a condition of an IF function in the while function is satisfied, the variable value of the variable A may be redefined as 1 (L7). It may be also possible that a new variable B (not shown) is newly declared and a variable value of the variable B is defined.

When the condition is not satisfied (e.g., the variable A is redefined as 1) and thus the repetition of the while function terminates, another function, for example, an IF function may be executed sequentially. In this case, the IF function may also use the variable A redefined in the while function as a condition (the second data use part 112b).

As described above, at least one of data definition parts 111a and 111b and at least one of data use parts 112a or 112b may exist in the programs 110 and 110a. The at least one of data definition parts 111a and 111b and the at least one of data use parts 112a and 112b may be recognized and identified by the second processor 200 and used to determine whether or not the programs 110 and 110a have been modified without authorization.

Various hacking (cracking) methods for the programs 110 and 110a will hereinafter be described.

Conventionally, it has been common that a hacker acquires an illegal access right to a predetermined electronic device by operating an arbitrarily distributed hacking file or inducing setting of a path unknown to a user. However, recently, a control hijacking attack is used. The control hijacking attack may be a method of directly hacking the flow of a program driving in the current system to automatically execute a hackers' desired hacking program. Control hijacking attacks may be classified into a code injection attack (CIA) and a code reuse attack (CRA). The code injection attack is a method of changing addresses of codes scheduled to be executed sequentially when a program operates to addresses corresponding to attack codes injected by a hacker to sequentially execute the attack codes injected by the hacker. The code reuse attack is a method of generating new attack codes by recombining codes existing in the storage of a device without injecting new codes. The code injection attack and the code reuse attack may be defeated by data execution prevention (DEP) and control-flow integrity (CFI), respectively.

However, the defense method may not defeat the CFB method. The CFB method may be a method of changing control flow by modulating data causing diverging of the control flow using the weak point of memory. In other words, the CFB method may modify data related to a condition causing diverging to change control flow in a hacker's desired direction, unlike the code reuse attack of modifying control flow by changing address values. Herein, the data related to the condition causing diverging may include the variable value (e.g., the value of the variable A) used as a condition in the data use part 112 of the program 110 described above.

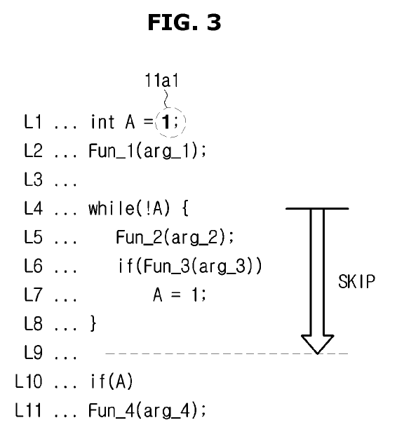

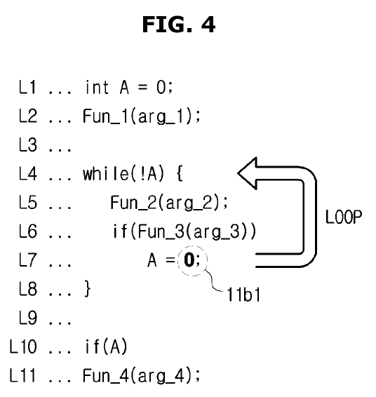

FIG. 3 is a view for describing an example of a CFB attack on the program shown in FIG. 2, and FIG. 4 is a view for describing another example of a CFB attack on the program shown in FIG. 2.

More specifically, for example, referring to FIG. 3, when a CFB attack is made on the program 110 shown in FIG. 2, the value of the variable A of the first line L1 may be changed from 0 to 1 (11a1), as shown in FIG. 3. Then, the value of the variable A may be defined as 1, and the condition of the while function that the variable A written in the fourth line L4 is false may be not satisfied, so that execution of the while function is skipped. In other words, a function of the tenth line L10 may be performed without performing the lines L4 to L8 corresponding to the while function. Likewise, execution of an IF function of another line, for example, the tenth line L10 may be skipped by defining the value of the variable A as a value that is different from the original value. As such, by modifying a variable value, it may be possible to change a program execution order to a hackers desired order or to prevent a specific program from being executed.

In addition, for another example, as shown in FIG. 4, the value of the newly redefined variable A may be defined as 0 instead of 1, while the while function is being performed (11b1). In this case, the value of the variable A may match the condition of the while function that the variable A written in the fourth line L4 is false, so that the while function continues to be repeatedly executed. Therefore, the fourth to eighth lines L4 to L8 may continue to be repeatedly executed, so that the program cannot be executed in a proper time. That is, the execution of the program may be interrupted in a similar manner to the case of denial of service.

The second processor 200 may monitor and determine whether or not such data (e.g., a variable value) is appropriate, to determine whether the program 110a performed by the first processor 100 has been modified without authorization. Therefore, it is possible to protect the apparatus 10 for defending against the unauthorized modification of the program from hackers' attacks.

Hereinafter, an embodiment in which the second processor 200 determines whether or not the program 110 has been modified without authorization when the program 110 shown in FIG. 2 is executed will be described.

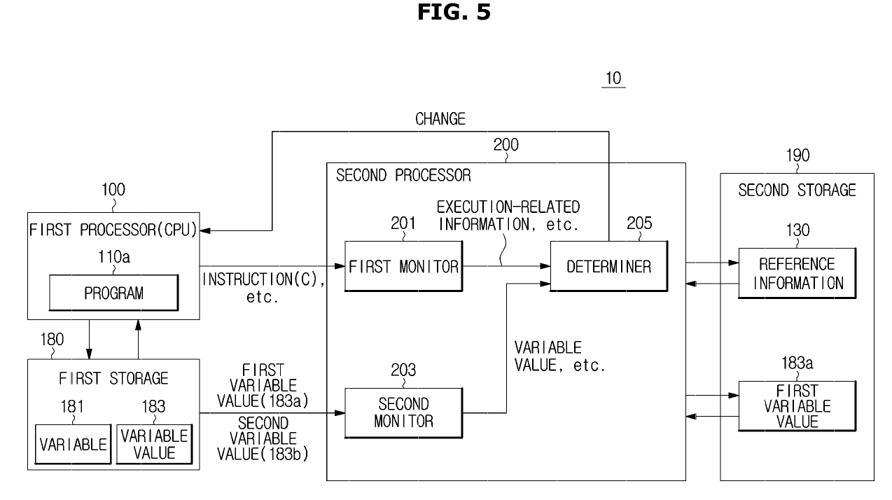

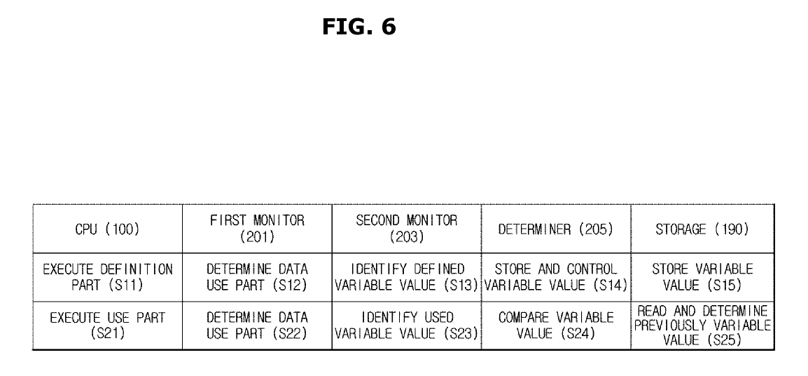

FIG. 5 shows a control flow of an apparatus for defending against an unauthorized modification of a program, and FIG. 6 is a table showing operations of individual components of an apparatus for defending against an unauthorized modification of a program, according to instructions executed.

Referring to FIG. 5, the second processor 200 may include a first monitor 201 for monitoring an instruction c executed by the first processor 100, a second monitor 201 for monitoring a variable 181 stored in the first storage 180 or a variable value 183 corresponding to the variable 181, and a determiner 205 for determining whether the program 110a executed by the first processor 100 has been modified without authorization based on information transmitted from the first monitor 201 and the second monitor 203.

The first monitor 201, the second monitor 203, and the determiner 205 may be physically or logically separated. In other words, the first monitor 201, the second monitor 203, and the determiner 205 may be implemented by using a plurality of different circuit elements or a plurality of semiconductor chips, respectively or by using a single circuit element or a single semiconductor chip.

When the first processor 100 executes the program 110a, the first monitor 201 may monitor whether a part being executed is a data definition part 111 or a data use part 112.

More specifically, for example, as shown in FIG. 6, when the first processor 100 executes the first line L1 of the program 110 to declare a variable and define the corresponding variable value, that is, a first variable value (i.e., when data is defined (s11)), the first monitor 201 may determine that the currently executed part is a data definition part 111 or 111a (s12), and output the result of the determination to the determiner 205. The result of the determination may be transmitted to the determiner 205 in the form of execution-related information. Here, the execution-related information may include information indicating that the current data definition parts 111 and 111a are being executed. The result of the determination may be transmitted to the second monitor 203 as necessary. The process may also be performed on the second data definition part 111b in the same manner.

In addition, for another example, when the first processor 100 executes the fourth line L4 of the program 110a (i.e., when the defined data is used (s21)), the first monitor 201 may determine that the currently executed part is a data use part 112 or 112a (s22), and output the result of the determination to the determiner 205. The result of the determination may be transmitted to the determiner 205 in the form of execution-related information. Herein, the execution-related information may include information indicating that the current data use parts 112 and 112a are being executed. The result of the determination may be transmitted to the second monitor 203 as necessary. The process may be performed on the second data use part 112b in the same manner.

The first monitor 201 may be implemented using, for example, an apparatus, a circuit, or a module for determining an operation state of the first processor 100. For example, the first monitor 201 may be implemented using a debugging interface or a debugging device that can identify an executed program 110a in units of lines.

The second monitor 203 may monitor a state of all or a part of a recording area (for example, the first storage 180) previously designated or not designated separately. More specifically, the second monitor 203 may acquire a writing state of data, a read-out state of data, an address at which data is recorded, and/or necessary information related to the storage 180.

When a variable is declared and/or a variable is defined as a specific variable value, the second monitor 203 may check an address (for example, an address of cache memory, main memory, or a stack) of the first storage 180 at which the variable value is stored, confirm the variable value from the address of the first storage 180 (s13 and s23), and then transmit the confirmed variable value to the determiner 205. More specifically, the second monitor 203 may confirm a first variable value 183a defined in the data definition part 111 (s13), and/or a second variable value 183b used in the data use part 112 (s23), and transmit the confirmed value to the determiner 205. Meanwhile, the variable values 183a and 183b may be stored in an apparatus selected from different apparatuses, for example, cache memory, main memory, and a stack, depending on a situation. In this case, the second monitor 203 may analyze the result of the determination transmitted from the first monitor 201 or an instruction C acquired by the first monitor 201, and determine which device the variable values 183a and 183b are actually stored in.

When the definition part of the program is being executed by the first processor 100 (s11), the confirmation of the first variable value 183a may be performed (s13). When the use part of the program is being executed by the first processor 100 (s12), the confirmation of the second variable value 183b may be performed (s23).

According to some embodiments, when the result of the determination is received from the first monitor 201, the second monitor 203 may identify and acquire at least one of the first variable value 183a and the second variable value 183b in response to the result of the determination.

The transmission of the first variable value 183a by the second monitor 203 may be performed simultaneously or sequentially with transmission of information indicating that the data definition part 111, 111a, or 111b is being executed by the first monitor 201. The transmission of the second variable value 183b by the second monitor 203 may be performed simultaneously or sequentially with transmission of information indicating that the data definition part 112, 112a, or 112b is being executed by the first monitor 201.

The determiner 205 may receive the execution-related information from the first monitor 201, and receive the first variable value 183a and the second variable value 183b from the second monitor 203. The determiner 205 may determine whether or not the program 100a has been modified without authorization using the execution-related information, the first variable value 183a, and the second variable value 183b.

More specifically, the determiner 205 may determine whether the variable value transmitted from the second monitor 203 is the first variable value 183a or the second variable value 183b, based on the execution-related information transmitted from the first monitor 201.

When the variable value transmitted from the second monitor 203 is determined to be the first variable value 183a, the determiner 205 may store the first variable value 183a in a predetermined storage, for example, the first storage 180 or the second storage 190 (s14 and s15). According to an embodiment, the second monitor 203 may store the first variable value 183a in the storage 180 or 190 using a snapshot method or a shadow stack method.

When the variable value transmitted from the second monitor 203 is determined to be the second variable value 183b, the determiner 205 may compare the second variable value 183b with the first variable value 183a (s24). For this, the determiner 205 may read the previously stored first variable value 183a from the storage 190 when the second variable value 183b is received (s25).

According to an embodiment, the determiner 205 may calculate a first hash value corresponding to the first variable value 183a and a second hash value corresponding to the second variable value 183b using a predetermined hash function, and compare the first hash value to the second hash value to determine whether the program 100a has been modified without authorization, instead of directly comparing the second variable value 183b to the first variable value 183a. When the determiner 205 determines that the first hash value is identical to the second hash value, the determiner 205 may determine that no unauthorized modification has occurred in the program 100a. When the determines 205 determines that the first hash value is different from the second hash value, the determiner 205 may determine that an unauthorized modification has occurred in the program 100a.

As the result of the comparison, when the determiner 205 determines that the first variable value 183a is identical to the second variable value 183b, the determiner 205 may determine that no unauthorized modification has occurred in the program 100a. When the determiner 205 determines that no unauthorized modification has occurred in the program 100a, the second processor 200, for example, the determiner 205 may not perform any additional operation, or may transmit information indicating that the program 110 has been not modified to the first processor 100. The first processor 100 may continue to execute the program 110a when receiving no information from the second processor 200 or when receiving information indicating that the program 110a has not been modified. The first processor 100 may execute the program 110a until the execution of the program 110a terminates normally or the program 100a is modified without authorization.

On the other hand, when the determiner 205 determines that the first variable value 183a is different from the second variable value 183b, the determiner 205 may determine that an unauthorized modification has occurred in the program 100a. When the determiner 205 determines that an unauthorized modification has occurred in the program 100a, the determiner 205 may execute a predefined operation. For example, the determiner 205 may transmit information indicating that the unauthorized modification has occurred to the first processor 100, and cause the first processor 100 to terminate the execution of the program 110a by itself or to perform a predefined operation. In addition, for another example, the determiner 205 may transmit a control signal for an execution stop instruction to the first processor 100, and cause the first processor 100 to stop executing the program 100a.

Operation in which the second processor 200 determines whether or not the program 100a has been modified without authorization may be repeatedly performed until the first processor 100 stops executing the program 110a.

According to an embodiment, the second processor 200 may further use the reference information 130 to determine whether or not the program 100a has been modified without authorization.

The reference information 130 may include control information required for an operation of the second processor 200 and/or information for determination criteria required for the determination process. For example, the reference information 130 may include a name or a kind of a variable declared during execution of the program 110 or 110a, a variable value of a specific variable, a function, operation, or purpose of a used function, information about whether a used function corresponds to a data definition part 111 or a data use part 112, information about an operation which the first monitor 201, the second monitor 203, and the determiner 205 need to perform in order to determine whether or not an unauthorized modification has occurred, and/or various kinds of information required for operations of the second processor 100. Herein, the information about the operation which the first monitor 201, the second monitor 203, and the determiner 205 need to perform in order to determine whether or not an unauthorized modification has occurred may include information about how the first monitor 201, the second monitor 203, and the determiner 205 operate in a specific situation, for example, when the data definition part 111 or the data use part 112 is executed.

The first monitor 201, the second monitor 203 and the determiner 205 of the second processor 200 may refer to the reference information 130 to perform, when a specific situation occurs, an operation corresponding to the specific situation. For example, the first monitor 201 may determine whether a currently executed instruction c corresponds to a data definition part 111 or a data use part 112 based on the reference information 130. The second monitor 202 may start performing an operation of checking a variable value 183 of the first storage 180 based on the reference information 130 or may determine an address where the variable value 183 is stored. Also, the determiner 205 may determine which one of the data definition part 111 and the data use part 112 the currently executed instruction c corresponds to, based on the reference information 130, and store the variable values 183a and 183b in the storages 180 and 190 or compare the variable values 183a and 183b, based on the result of the determination.

According to an embodiment, the reference information 130 may be generated by at least one of the first processor 100 and the second processor 200. In this case, the at least one of the first processor 100 and the second processor 200 may analyze the program 110, determine a location of diverging data (i.e., the data definition part 112 and the data use part 113), and generate the reference information 130 corresponding to the program 110 by combining the results of the determination. For this, the at least one of the first processor 100 or the second processor 200 may analyze an executable file of the program 110. The reference information 130 may be generated before the program 110 is executed. For example, the program 110 may be executed when or immediately after the program 110 is installed in the apparatus 10 for defending against the unauthorized modification of the program.

According to another embodiment, the reference information 130 may be received from another device, instead of the apparatus 10 for defending against the unauthorized modification of the program. For example, the reference information 130 may be received from a server apparatus that has provided the program 110 to the apparatus 10 for defending against the unauthorized modification of the program through a wire/wireless communication network. Herein, the server device may be a computing device used for an electronic software distribution network. In this case, the reference information 130 may be provided to the apparatus 10 for defending against the unauthorized modification of the program, together with the program 110. In other words, the reference information 130 may be provided to the apparatus 10 for defending against the unauthorized modification of the program at substantially the same time as when the program 110 is provided. Also, the reference information 130 may be provided to the apparatus 10 for defending against the unauthorized modification of the program separately from the program 110 according to a user's selection or according to a predefined setting.

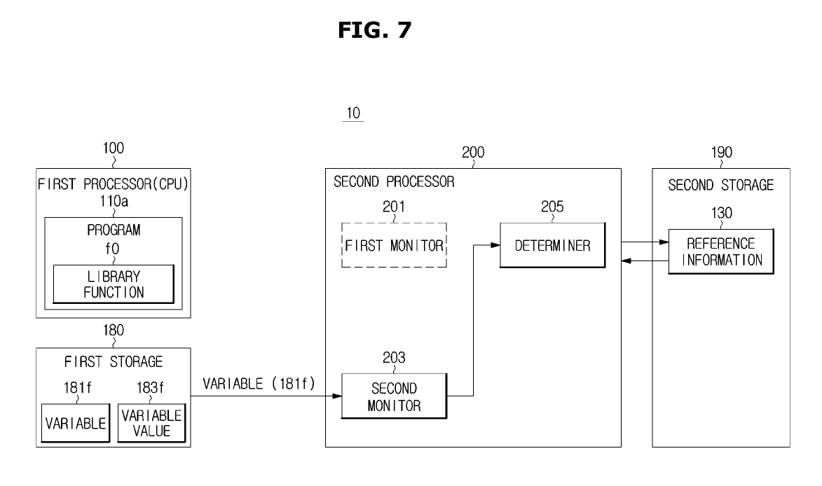

FIG. 7 shows a control flow of an apparatus for defending against an unauthorized modification of a program when the program uses a library function.

As shown in FIG. 7, the predetermined program 110a may include a library function f0, and the first processor 100 may execute the program 110a including the library function f0.

The library function f0 means a predefined function (including a routine or a subroutine) for a programmers convenience. The library function f0 may include a function that can be relatively easily modified since a return address or a processing order can be changed due to a modification of an argument. The function is generally called a dispatcher function. For example, the C language may include a dispatcher function, such as a printf function, a memcpy function, a strcat function, an exec function, and a system function. The above-mentioned dispatcher functions may be more vulnerable to a hacking method such as a CFB method because they perform an abnormal operation only by changing an argument (i.e., a variable value).

According to an embodiment, the second processor 200 may determine whether or not a variable 181f and/or a defined variable value declared for the library function f0 or in the library function f0 has been modified without authorization, in order to determine whether the program 110a using the library function f0 has been modified without authorization.

More specifically, referring to FIG. 7, the second processor 200 of the apparatus 10 for defending against the unauthorized modification of the program may include the first monitor 201 for monitoring whether a library function is used in the first processor 100, the second monitor 203 for monitoring a variable 181f stored in the storage 180 or a variable value 183f corresponding to the variable 181f, and the determiner 205 for determining whether the program 110a executed by the first processor 100 and/or the library function f0 has been modified according to the result of monitoring transmitted from the second monitor 203.

The first monitor 201 may monitor whether or not the library function f0 is called. When the library function f0 is called, the first monitor 201 may provide information to the second monitor 203 and the determiner 205 with information indicating that the library function f0 is being called and used. The first monitor 201 may be omitted according to some embodiments.

When the information indicating that the library function f0 is being called and used is received from the first monitor 201 or when it is time to call the library function of the reference information 130, the second monitor 203 may monitor and check the first monitor 180. More specifically, the second monitor 203 may monitor an area (for example, the stack part of the first storage 180) in which a variable (i.e., the parameters 181f) of the library function f0 is stored to determine whether or not the variable 181f or a variable value 183f corresponding to the variable 181f has been modified without authorization. Herein, the area in which the variable is stored may have been decided according to the library function f0. The second monitor 203 may determine the number or type (for example, information about whether the declared variable is an integer int, a character char, or a float) of the variable 181f stored in the area of the first storage 180, or may determine whether the variable value 183f itself has been properly copied in the area of the first storage 180 to determine whether the variable 181f or the variable value 183f has been modified without authorization.

When the variable value 183f has been modified without authorization, the second processor 200 may determine that the called library function f0 has been modified without authorization, and accordingly, that the program 110a executing on the first processor 100 has been modified without authorization. The determination may be made directly by the second monitor 203, or may be made by the determiner 205 based on information (e.g., the number of the variable 181f stored in the first storage 180, the type of the variable 181f, and/or the variable value 183f) transmitted from the second monitor 203.

Since the variable 181f and the variable value 183f declared and defined by the library function f0 are previously known information, the second monitor 203 or the determiner 205 may determine whether or not the variable value 183f has been modified without authorization by using the known information. The reference information 130 stored in the storages 180 and 190, for example, the second storage 190 may be used to determine the variable 181f and the variable value 183f declared and defined by the library function f0.

When it is determined that the library function f0 and the program 110a have been modified without authorization, for example, the second monitor 203 or the determiner 205 of the second processor 200 may transmit information about the unauthorized modification of the program 110a to the first processor 100 in the form of an electrical signal so as for the first processor 100 to stop executing the program 110a or to perform a predefined operation. For another example, when it is determined that the library function f0 and the program 110a have been modified without authorization, the second monitor 203 or the determiner 205 may transmit a control signal for an execution stop instruction to the first processor 100 so that the first processor 100 stops executing the program 100a. The execution of the program 110a including the modified library function f0 may be stopped by the first processor 100.

On the contrary, when it is determined that the library function f0 and the program 110a have been not modified without authorization, the second processor 200 may not perform any operation, or transmit information indicating that the program 110a has been not modified without authorization to the first processor 100. When the first processor 100 receives no information or receives the information indicating that the program 110a has been not modified without authorization, the first processor 100 may continue to execute the program 110a until the program 110a terminates.

While the program 110a is being executed by the first processor 100, operation in which the second processor 200 determines whether the program 110a has been modified without authorization may be continuously and repeatedly performed.

According to an embodiment, the determiner 205 may determine integrity of the library function f0 in addition to determining whether the library function f0 and the program 110a have been modified without authorization. The determination on the integrity of the library function f0 may be made before the program 110a is executed by the first processor 100 or before the library function f0 is called after the program 110a is executed. It may also be possible that the determination on the integrity of the library function f0 is made when the library function f0 is called.

Specifically, for example, the determiner 205 may determine whether or not a variable 181f (parameter) of the library function f0 is appropriate, and more specifically, for example, the determiner 205 may determine whether the number of the variable 181f of the library function f0 is within an appropriate range, whether the declared variable 181f is appropriate, or whether the defined variable value 183f matches with the type of the declared variable 181f or is within a predetermined range, and/or other conditions required for determining the integrity of the library function f0.

The reference information 130 may also be used to determine whether the program 110a using the library function f0 has been modified, as described above. In this case, the reference information 130 may include various information required for monitoring the library function f0, such as information for identifying the library function f0, information about the variable 181f declared by the library function f0, information about a variable value 183f defined or definable for the variable 181f, information about a storage location of the variable 181f or the variable value 183f, and/or information about a time at which the library function is called. The reference information 130 may be transmitted to at least one of the first monitor 201, the second monitor 203, or the determiner 205 through a wire or a circuit, if necessary.

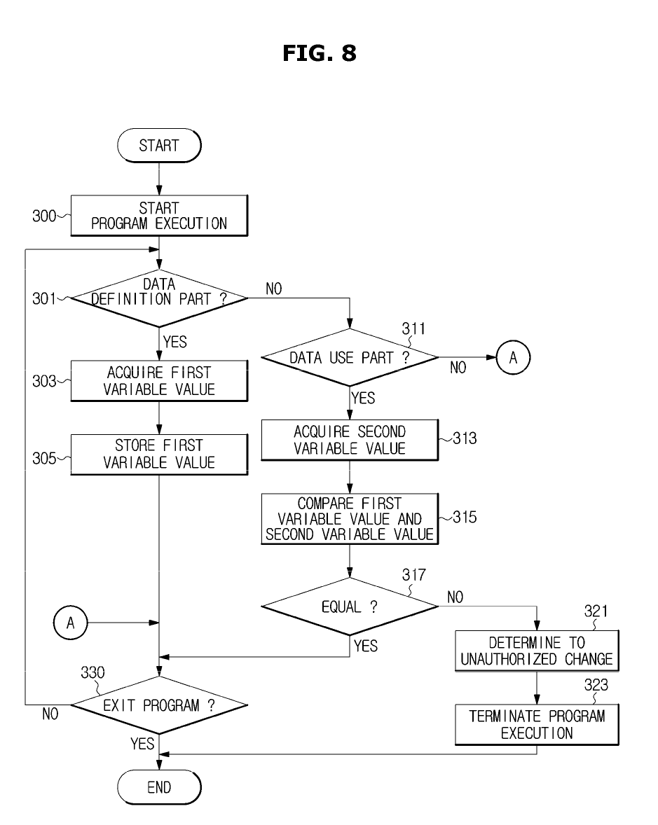

Hereinafter, various embodiments of methods for defending against an unauthorized modification of a program will be described with reference to FIGS. 8 to 10.

FIG. 8 is a flowchart illustrating an embodiment of a method for defending against an unauthorized modification of a program.

A method for defending against an unauthorized modification of a program may be performed, for example, by an apparatus for defending against an unauthorized modification of a program. The apparatus for defending against the unauthorized modification of the program may be, for example, a display, a terminal device such as a set-top box or a desktop computer, a home electric appliance, various industrial machines or devices, etc. The apparatus for defending against the unauthorized modification of the program may include a first processor and a second processor. The first processor and the second processor may be physically or logically separated from each other. The first processor and the second processor may be provided so that one of them can perform a predetermined operation while the other one can perform another operation.

As shown in FIG. 8, the first processor of the apparatus for defending against the unauthorized modification of the program may start executing a stored program (operation 300). When the program is executed, the second processor may monitor the program executed by the first processor. Specifically, the second processor may monitor a part of the program executed by the first processor in real time (operation 301). For example, the second processor may determine a part being currently executed by the first processor.

When the part being currently executed by the first processor is a data definition part (“YES” in operation 301), the second processor may identify and acquire a variable value defined by the data definition part, that is, a first variable value (operation 303). Specifically, the second processor may monitor a storage (e.g., a first storage) in which a variable value transmitted from the first processor is stored to identify and acquire a first variable value. Herein, the data definition part may be a part defining data, a statement declaring a variable and/or a statement defining a variable.

When the first variable value is acquired, the second processor may store the first variable value in a separate storage, for example, a second storage. According to an embodiment, the second processor may store the first variable in an area that is different from an area of the first storage in which the first variable has been stored by the first processor.

Thereafter, when the program continues to be executed by the first processor without terminating (“NO” in operation 330), the second processor may monitor a part of the program executed by the first processor 100 in real time.

When the part being currently executed by the first processor 100 is not a data definition part but a data use part (“NO” in operation 301 or “YES” in operation 311), the second processor may identify and acquire a variable value used by the data use part, i.e., a second variable value (operation 313). In this case, the second processor may monitor the storage (e.g., the first storage 180) in which the variable value transmitted from the first processor 100 is stored to identify the second variable value, as described above. Herein, the data use part may be a part using predefined data, and include, for example, a part where a function, a routine, or a subroutine exists.

When the second variable value is identified, the second processor 200 may compare the second variable value to a pre-stored first variable value (operation 315). When there is no pre-stored first variable value, the second processor may determine that an error has occurred upon the execution of the program, and perform a predetermined operation, such as terminating the program and/or notifying the user of the occurrence of the error, etc.

When the first variable is identical to the second variable value (“YES” in operation 311), the second processor 200 may determine that no unauthorized modification has occurred in the current data use part. In this case, if necessary, the second processor 200 may transfer information informing that no unauthorized modification has occurred to the first processor.

When no unauthorized modification has occurred, the execution of the program by the first processor may continue to be performed without terminating. The above-described operations 301 to 311 may be repeated until the execution of the program appropriately terminates according to a predetermined setting (operation 330). The second processor may continue to monitor the program while the program is being executed.

When the first variable value is different from the second variable value (“NO” in operation 311), the second processor may determine that an unauthorized modification has occurred in the current data use part (operation 321).

In this case, the second processor 200 may cause the first processor 100 to stop executing the program by providing the first processor 100 with information informing that an unauthorized modification has occurred or by transmitting a control signal for stopping executing the program (operation 323).

When the part in which the program is executed is neither the data definition part nor the data determination part, the second processor may perform none of the above-described operations 303, 305, and 313 to 323.

Operation 301 of determining the data definition part, operation 311 of determining the data use part, and/or operations 303 and 313 of acquiring the variable values may be performed based on reference information provided from the outside or generated by the apparatus for defending against the unauthorized modification of the program.

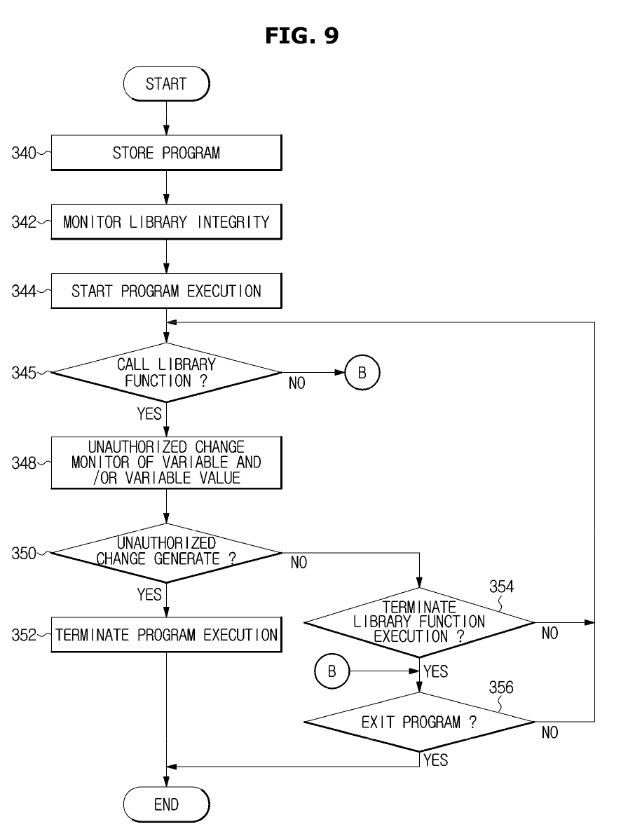

FIG. 9 is a flowchart illustrating another embodiment of a method for defending against an unauthorized modification of a program.

Referring to FIG. 9, an apparatus for defending against an unauthorized modification of a program may acquire and store a program (operation 340). The program may be received generally from an external device, such as a USB memory, a compact disk, or an external computing device (server device), and be stored in a storage (operation 340). However, the program may be input to a computer by a programmer and stored in the computer.

The program may be a program coded using at least one library function.

When the program is stored, the second processor may check integrity of the library function. For example, the second processor may check integrity of the library function by determining whether variables and/or defined variable values of the library function are appropriate. When a problem is found in the integrity of the library function, the second processor may output, alone or together with the first processor, an error message to the outside and/or prevent the program from being executed, according to a predefined definition. However, the operation may be performed only by the first processor.

Thereafter, the program may be executed by the first processor according to a user's manipulation or a predetermined setting (operation 344).

When the program is executed, at least one library function may be called (“YES” in operation 345). When no library function is called, the second processor may determine whether the library function is called or used until the program terminates normally (operation 356).

When the library function is called, the second processor may determine whether a variable and/or a variable value declared, used or defined by the library function has been modified (operation 348). Determination on whether or not the variable and/or the variable value has been modified without authorization may be made by checking a predetermined storage, for example, the first storage where the variable and/or the variable value of the library function is stored. For example, when a variable value of a predetermined variable is defined as a specific value by the library function, the second processor may check an area of the first storage in which the variable and/or the variable value will be stored, and determine whether the specific value is properly copied and stored in the area of the first storage, thereby determining whether the variable and/or the variable value has been modified without authorization.

When an unauthorized modification has occurred in the variable and/or the variable value (“YES” in operation 350), the second processor 200 may provide information informing that a modification has occurred to the first processor, or transmit a control signal for stopping executing the program to the first processor to thus cause the first processor to stop executing the program (operation 352).

When no unauthorized modification has occurred in the variable and/or the variable value (“NO” in operation 350) and the execution of the library function has not terminated (operation 354), the second processor may continue to monitor whether the library function is called (operation 345). When the library function is called (“YES” in operation 345), the second processor may repeatedly determine whether the variable and/or the variable value has been modified without authorization (operations 348 and 350).

When the program has not yet terminated normally (“NO” in operation 356) even when the execution of the library function has terminated (YES in operation 354), the above-mentioned operations 345 to 354 may be repeatedly performed (operation 356).

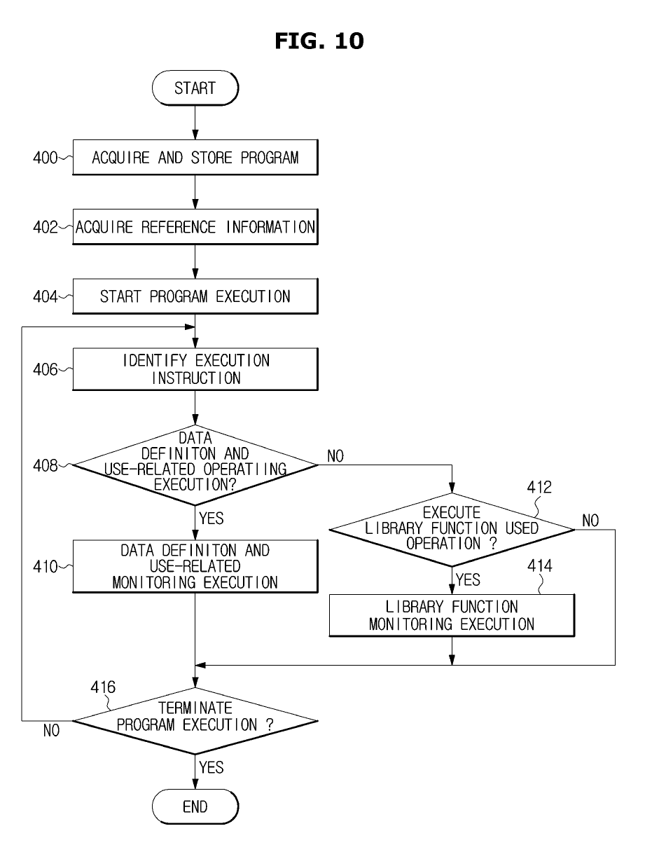

FIG. 10 is a flowchart illustrating still another embodiment of a method for defending against an unauthorized modification of a program.

The methods for defending against the unauthorized modification of the program, as described above with reference to FIGS. 8 and 9, may be used in combination, as shown in FIG. 10.

Specifically, referring to FIG. 10, the apparatus for defending against the unauthorized modification of the program may acquire a program input by a designer or received from an external device, and store the program in the storage (operation 400).

The apparatus for defending against the unauthorized modification of the program may acquire reference information when or after acquiring the program (operation 402). The reference information may be received from the outside, or may be generated and acquired directly by the apparatus for defending against the unauthorized modification of the program through analysis of the program. The reference information may include control information related to operations for defending against a modification of the program and/or information for determination criteria required for the determination process

The program may be executed by the first processor (operation 404).

The second processor may determine which operation is being executed by the first processor, in real time (operation 406). For example, the second processor may determine which instruction or function is being currently executed by the first processor 100.

When an operation being performed by the first processor is an operation of processing a data definition part and/or a data use part (“YES” in operation 408), the second processor may perform the operation of processing the data definition part and/or the data use part (operation 410). Specifically, for example, the second processor may perform operations 301 to 323 shown in FIG. 8.

When the first processor is not performing an operation of processing a data definition part and/or a data use part but performing an operation of calling a library function and using it (“NO” in operation 408 and “YES” in operation 412), the second processor may perform an operation of monitoring the library function (operation 414). For example, the second processor may perform operations 345 to 354 shown in FIG. 9. In this case, an operation 342 of checking integrity of the library function, as shown in FIG. 9, may be performed before the operation 404 of executing the program.

When the operation being performed by the first processor 100 is neither an operation of processing a data definition part and/or a data use part nor an operation of calling a library function, the second processor may operate according to a predefined setting (“NO” in operation 412). For example, the second processor may not perform any operation related to determination on whether or not an unauthorized modification has occurred.

When the program execution operation of the first processor 100 has not terminated (“NO” in operation 416), the above-described operations 406 to 414 may be repeated. On the contrary, when the program execution operation of the first processor has terminated (“YES” in operation 416), the method for defending against the unauthorized modification of the program may also terminate accordingly.

The method for defending against the unauthorized modification of the program according the above-described embodiment may be implemented in the form of a program that can be executed by a computer device. The program may include program instructions, data files, and data structures alone or in combination. The program may be designed or manufactured by using a machine language code or a high level language code. In addition, the program may be particularly designed to implement the above-described methods or may be implemented by using various functions or definitions that are well-known and available to a group of ordinary skill in the computer software field.

A program for implementing the method for defending against the unauthorized modification of the program may be recorded on computer-readable recording medium. The computer-readable recording medium may include various types of hardware devices capable of storing specific programs that are executed in response to a call from a computer, e.g., magnetic disk storage media such as a hard disk or a floppy disk, optical recording media such as a magnetic tape, a compact disc (CD) or a DVD, magneto-optical recording media such as a floptical disk, and semiconductor memory devices such as ROM, RAM, or flash memory.

Hereinbefore, various embodiments of the apparatus for defending against the unauthorized modification of the program and the method for defending against the unauthorized modification of the program have been described. However, the apparatus and the method are not limited to the above-described embodiments. Various apparatuses or methods that can be implemented by one of ordinary skill in the related art through correction and modification based on the above-described embodiments may also be examples of the above-described apparatus and method for defending against the unauthorized modification of the program. For example, although the above-described techniques are performed in a different order from that of the above-described method, and/or the above-described components, such as system, structure, apparatus, and circuit, are coupled or combined in a different form from that of the above-described method, or replaced or substituted with other components or equivalents, proper results can be achieved.

According to the apparatus and method for defending against the unauthorized modification of the program as described above, it may be possible to appropriately defend against external attacks on the program, such as an unauthorized modification or an unauthorized modification attempt, thereby enhancing the safety of programs scheduled to be executed or being executing.

According to the apparatus and method for defending against the unauthorized modification of the program as described above, it may also be possible to improve the vulnerability of programs to hacking attacks such as a CFB attack that changes the execution flow of programs.

According to the apparatus and method for defending against the unauthorized modification of the program as described above, there is no need to add a code for checking whether a program has been modified without authorization in the program, thereby eliminating inconvenience of analyzing a source code of the program or an application binary executable file. It may also be possible to prevent the execution speed of the program from being lowered due to the code for checking whether the program has been modified without authorization.

In addition, according to the apparatus and method for defending against the unauthorized modification of the program as described above, when a malicious code is added in a process of updating the program, it may be possible to immediately respond to the malicious code and defend it.

Further, according to the apparatus and method for defending against the unauthorized modification of the program as described above, it may be possible to improve the vulnerability of a program created using a library function having relatively low security.

Although a few embodiments of the present disclosure have been shown and described, it would be appreciated by those skilled in the art that changes may be made in these embodiments without departing from the principles and spirit of the invention, the scope of which is defined in the claims and their equivalents.

What is claimed is:

1. An apparatus for defending against an unauthorized modification of a program, the apparatus comprising:
a first processor configured to execute a program; and
a second processor configured to monitor an execution state of the program being executed by the first processor,
wherein the second processor is configured to:
acquire a first value of a defined variable when a data definition part of the program is executed; and
determine whether the program has been modified without authorization based on a result of comparison between the first value and a second value used as a value of the variable when a data use part of the program is executed.

2. The apparatus according to claim 1, wherein the second processor is independent of the first processor.

3. The apparatus according to claim 1, wherein the second processor determines that the program has been not modified without authorization when the first value is identical to the second value, and determines that the program has been modified without authorization when the first value is different from the second value.

4. The apparatus according to claim 3, wherein the second processor controls the first processor to stop executing the program according to the determination of whether the program has been modified without authorization.

5. The apparatus according to claim 1, wherein the second processor acquires reference information, corresponding to the program and related to the data definition part and the data use part, by analyzing the program before the first processor executes the program or by receiving the reference information from another computing device.

6. The apparatus according to claim 5, wherein the second processor determines whether a part of the program being executed by the first processor is the data definition part or the data use part by using the reference information.

7. The apparatus according to claim 1, further comprising a storage configured to store a value of at least one variable defined by the data definition part of the program.

8. The apparatus according to claim 7, wherein the first processor calls and executes a library function, and stores a variable defined by the library function or a value of the variable in the storage, and the second processor determines whether the variable or the value of the variable stored in the storage has been modified without authorization, and determines whether the program has been modified without authorization based on a result of the determination.

9. The apparatus according to claim 8, wherein the second processor checks integrity of the library function before the program is executed by the first processor.

10. The apparatus according to claim 6, wherein the second processor comprises a first monitor configured to monitor an operation of the first processor and a second monitor configured to monitor a state of the storage.

11. An apparatus for defending against an unauthorized modification of a program comprising:
a storage;
a first processor configured to execute at least one library function included in the program and to store at least one variable defined by the at least one library function or a value corresponding to the at least one variable stored in the storage; and
a second processor configured to determine whether or not the program has been modified without authorization according to a determination on whether the variable or the value of the variable stored in the storage has been modified without authorization

12. A method for defending against an unauthorized modification of a program comprising:
by a first processor, executing a program;
by a second processor, acquiring a first value of a defined variable when a data definition part of the program is executed;
by the second processor, comparing the first value with a second value used as a value of the variable when a data use part of the program is executed; and
by the second processor, determining whether the program has been modified without authorization based on a result of the comparison.

13. The method according to claim 12, wherein the determining of whether the program has been modified without authorization based on the result of the comparison comprises at least one of:
by the second processor, determining that the program has been not modified without authorization when the first value is identical to the second value; and
by the second processor, determining that the program has been modified without authorization when the first value is different from the second value.

14. The method according to claim 13, further comprising, by the second processor, controlling the first processor to stop executing the program in response to the determination that the program has been modified without authorization.

15. The method according to claim 12, further comprising, by the second processor, acquiring reference information corresponding to the program and related to the data definition part and the data use part,
wherein the acquiring of the reference information comprises at least one of:
analyzing the program to acquire the reference information before the first processor executes the program; and
receiving the reference information from another computing method to acquire the reference information.

16. The method according to claim 15, wherein the determining of whether the program has been modified without authorization based on the result of the comparison further comprises:
by the second processor, determining whether a part of the program being executed by the first processor is the data definition part or the data use part by using the reference information.

17. The method according to claim 12, further comprising storing a value of at least one variable defined by the data definition part of the program in a storage.

18. The method according to claim 17, further comprising:
at the first processor, calling and executing a library function;
storing a variable defined by the library function or a value of the variable in the storage;
by the second processor, determining whether the variable or the value of the variable stored in the storage has been modified without authorization; and
determining whether the program has been modified without authorization based on a result of the determination.

19. The method according to claim 18, further comprising, at the second processor, checking integrity of the library function before the program is executed by the first processor.

20. The method according to claim 17, further comprising at least one of:
by the second processor, monitoring an operation of the first processor; and
by the second processor, monitoring a state of the storage.
